(19) United States
(12) Patent Application Publication
(10) Pub. No.: US 2005/0285536 A1
(43) Pub. Date: Dec. 29, 2005

(54) Discharge tube

(75) Inventor: Kazuhiko Machida, Nagano-shi (JP)

Correspondence Address: STAAS & HALSEY LLP, SUITE 700, 1201 NEW YORK AVENUE, N.W., WASHINGTON, DC, 20005, US

(73) Assignee: SHINKO ELECTRIC INDUSTRIES CO., LTD., Nagano (JP)

(21) Appl. No.: 11/122,048

(22) Filed: May 5, 2005

(30) Foreign Application Priority Data
Jun. 23, 2004 (JP) 2004-184988

(51) Int. Cl. H01J 17/00

(52) U.S. Cl. 313/635

(57) ABSTRACT

A discharge tube comprised of a cylinder ceramic envelope sealed at its two ends by plate-shaped positive electrode and negative electrode, wherein the entire outside circumference of at least the negative electrode end of the ceramic envelope is printed with insulating ink, whereby it is possible to prevent insulation degradation due to deposition or dirt or moisture on the surface of the envelope and greatly lighten the burden of handling and maintenance and management.

### BACKGROUND OF THE INVENTION

1. Field of the Invention

The present invention relates to a discharge tube comprised of a cylindrical ceramic envelope sealed at the two ends by plate-shaped positive electrode and negative electrode.

2. Description of the Related Art

A discharge tube operates at a high voltage, so it is particularly important to stably secure insulation. Insulation is extremely sensitive to dirt or moisture adhering to the outer surface of the ceramic envelope. Even with a very small amount of deposition, insulation degradation occurs and a drop in the discharge voltage is incurred. For example, even if a person just touches it with his bare hand or if moisture condenses on it from the air, insulation degradation will easily occur.

Therefore, in the past, much trouble had been required for the handling of discharge tubes and their maintenance and management.

### SUMMARY OF THE INVENTION

An object of the present invention is to provide a discharge tube which prevents insulation degradation due to deposition or dirt or moisture on the surface of the envelope and greatly lightens the burden of handling and maintenance and management.

To achieve the above object, according to the present invention, there is provided a discharge tube comprised of a cylinder ceramic envelope sealed at its two ends by plate-shaped positive electrode and negative electrode, wherein the entire outside circumference of at least the negative electrode end of the ceramic envelope is printed with insulating ink.

In the present invention, by printing on the entire outside circumference of at least the negative electrode end of the ceramic envelope of the discharge tube with insulating ink, it is possible to effectively prevent the insulation degradation which had occurred in the past.

### BRIEF DESCRIPTION OF THE DRAWINGS

These and other objects and features of the present invention will become clearer from the following description of the preferred embodiments given with reference to the attached drawings, wherein:

FIG. 1 is a side view of an example of a discharge tube provided with printing according to the present invention;

FIG. 2 gives side view of different types of printing according to the present invention;

FIG. 3 is a side view of a discharge tube provided with printing of a preferred embodiment of the present invention;

FIG. 4 is a graph showing a chart of measurement of the discharge voltage of a discharge tube, wherein (1) shows an example of measurement of a rated discharge voltage and (2) shows an example of measurement of a discharge voltage greatly reduced from the rating due to insulation degradation;

FIG. 5 is a graph of results of measurement of FVs in a temperature humidity bias (THB) test; and

FIG. 6 is a graph of results of measurement of Vs in a temperature humidity bias (THB) test.

### DESCRIPTION OF THE PREFERRED EMBODIMENTS

The inventors discovered that by printing on the entire outside circumference of at least the negative electrode end of the ceramic envelope of a discharge tube with an insulating ink, it is possible to effectively prevent the insulation degradation which had occurred in the past. The reasons are not yet elucidated, but are believed to be as follows.

(1) The cause of insulation degradation due to the slight amount of dirt or moisture deposited on the outside circumference of the ceramic envelope is the occurrence of some sort of electrostatic interference between the carbon trigger wires at the inside circumference of the ceramic envelope and the dirt or moisture at the outside circumference. The effect of this is particularly remarkable near the negative electrode.

(2) If an insulation coating is formed by printing insulating ink at the outside circumference of the ceramic envelope at the negative electrode side, the dirt or moisture will not deposit directly on the ceramic envelope since an insulation coating will be interposed. The phenomenon of insulation degradation originally occurs due to very small amounts of dirt or moisture. The occurrence is greatly influenced by the surface conditions of the ceramic envelope. The presence of the insulation coating obtained by the printed ink causes the conditions for occurrence to be lost and prevents insulation degradation.

In the past, the outside surface of the ceramic envelope of a discharge tube had been printed with the company mark, discharge voltage, date of manufacture, etc. as labeling information to the extent allowable in the surface area.

In the present invention, if printing on the entire outside circumference of at least the negative electrode end of the ceramic envelope with an insulating ink in addition to the conventional printing, the effect of preventing insulation degradation is obtained.

The insulating ink used for the printing in the present invention may be the ink conventionally used for printing. However, when it is necessary to further enhance the effect of prevention of insulation degradation, it is also possible to further print on the envelope using as an ink a high insulating coating material.

Further, if printing on only the negative electrode end, there are the following secondary advantages:

First, the positive electrode and negative electrode sides can be discerned at a glance. This is extremely convenient in practice for manufacturers, distributors, and users.

Further, the product yield is improved. That is, the characteristics of discharge tubes are generally bidirectional, but customers use them with DC power sources, so single direction characteristics are sufficient. Therefore, by printing on the outside circumference of only the negative electrode end of the ceramic envelope (or printing on the two ends so as to enable the negative electrode and the positive electrode to be discriminated), it is possible to employ even products satisfying the requirements only in one direction, so the product yield can be improved. Further, the trouble of determining the characteristics in the two directions can be eliminated.

Further, if printing a bar code, it is possible to provide detailed information such as the production lot number in addition to the usually provided company mark, discharge voltage, and date of manufacture.

The printing has to surround the entire outside circumference of the negative electrode end of the ceramic envelope, but does not necessarily always have to be continuous along the outside circumference and in some cases may also be intermittent.

The end faces of the ceramic envelope and the electrode plates are joined by a binder such as silver solder, but the connecting parts inevitably have microscope cavities due to relief shapes due to the binder. If printing so as to cover at least the connecting part of the negative electrode end of the ceramic envelope and the negative electrode, it is possible to prevent entry of moisture from the microscope cavities of the connecting part, so the effect of prevention of insulation degradation is further enhanced. The entry of moisture from the negative electrode end has a great effect on the insulation degradation, so if printing to cover at least the connecting part at the negative electrode end, there is a great sealing effect against entry of moisture. Of course, if printing to cover the connecting part at the positive electrode end in addition to the negative electrode end, the effect of prevention of entry of moisture is further enhanced.

### EXAMPLES

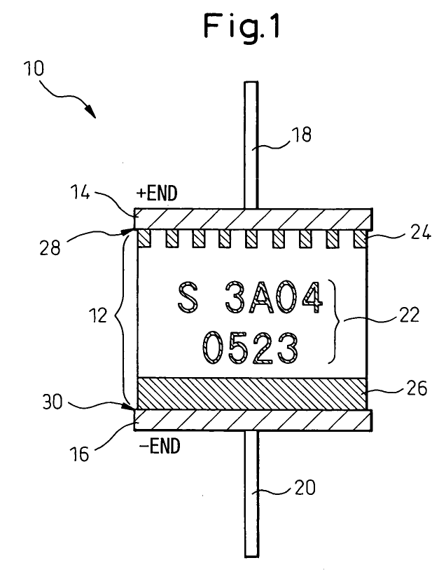

FIG. 1 shows an example of a discharge tube provided with the printing according to the present invention by a side view. The discharge tube 10 of the present invention is structured as a cylindrical ceramic envelope 123 sealed at its two ends by a plate-shaped positive electrode 14 and negative electrode 16 from which a positive electrode lead wire 18 and negative electrode lead wire 20 extend and is provided with printing 26 of insulating ink extending continuously around the entire outside circumference of the end of the ceramic envelope 12 at the negative electrode 16 side. The outside circumference of the body of the ceramic envelope 12 is provided with printing 22 similar to the conventional case and shows the company mark “S”, the discharge voltage “3A04”, the date of manufacture “0523”. Further, in the illustrated example, the end at the positive electrode 14 side is also provided with printing 24 intermittently extending across the entire outside circumference. These printings 22, 24, and 26 are all made of the same ink.

In the illustrated example, the printing 26 at the negative electrode end and the printing 24 at the positive electrode end are both provided at the ceramic envelope according to the present invention. The connecting part 28 between the positive electrode 14 and the ceramic envelope 12 and the connecting part 30 between the negative electrode and the ceramic envelope 12 are not covered.

In the illustrated example, in addition to the printing 26 at the negative electrode 16 side, the positive electrode 14 side is also provided with printing 24, but this is to assist visual recognition of the direction of the positive electrode. So long as providing the printing 26 at the negative electrode 16 side, it is possible to obtain the effect of prevention of insulation degradation according to the present invention regardless of the presence or absence of the printing 24 at the positive electrode 14 side.

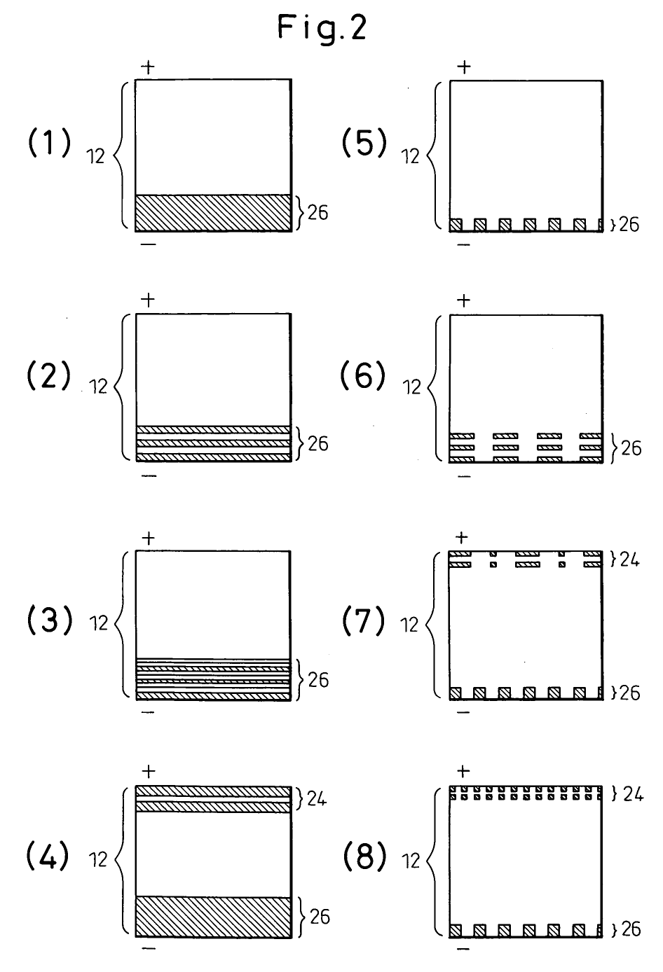

FIG. 2 shows various embodiments of printing according to the present invention by side views. In the figure, to facilitate the illustrations, only the ceramic envelopes of the discharge tubes are shown. Illustrations of the positive and negative electrodes and the lead wires are omitted. Further, in the same sense, illustrations of the conventional printed parts such as shown by the reference numeral 22 in FIG. 1 are omitted. In (1) to (8) of FIG. 2, as shown by the “+” and “−”, the top ends are the positive electrode sides and the bottom ends are the negative electrode sides. The ceramic envelopes are cylindrical in shape with the center axes of the cylinders running along the vertical directions in the illustrations.

FIG. 2(1) shows the most basic mode of printing. A single printing 26 running continuously across the entire outside circumference of the negative electrode end (bottom end in the figure) of the ceramic envelope 12 is provided. This enables the effect of prevention of insulation degradation of the present invention to be obtained.

The printing 26 in the embodiment of FIG. 2(1) may also be comprised of three parallel lines as shown in FIG. 2(2). Alternatively, it may be comprised of a plurality of parallel lines as shown in FIG. 2(3). In these embodiments as well, an effect of prevention of insulation degradation equivalent to that of the embodiment of FIG. 2(1) is obtained.

The embodiment of FIG. 2(4), like the embodiment of FIG. 2(1), is provided with a single printing 26 extending continuously over the entire outside circumference of the negative electrode end (bottom end in the figure) of the ceramic envelope 12 and is further provided with two printings 24 extending continuous over the entire outside circumference at the positive electrode end (top end in the figure) of the ceramic envelope 12 as well. By printing at the two ends, the positive and negative directions can be shown more clearly and made easier to understand compared with printing at only the negative electrode side. In this embodiment as well, an effect of prevention of insulation degradation equivalent to that of the embodiment of FIG. 2(1) is obtained.

The embodiment of FIG. 2(5) changes the continuous printing 26 of the embodiment of FIG. 2(1) to an intermittent one. Such intermittent printing is also allowed so long as the effect of prevention of insulation degradation is obtained and enables greater diversity in design.

Similarly, the embodiment of FIG. 2(6) changes the continuous printing of the embodiment of FIG. 2(2) to an intermittent one. Such intermittent printing is also allowed so long as the effect of prevention of insulation degradation is obtained and enables greater diversity in design.

The embodiments of FIGS. 2(7) and (8) change the printings 26 of the positive and negative electrode ends of the embodiment of FIG. 2(4) to intermittent ones and enable greater diversity in design.

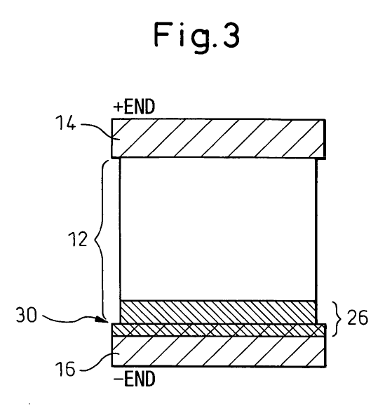

FIG. 3 shows an example of a preferred embodiment of the present invention comprised of a cylindrical ceramic envelope 12 sealed by a positive electrode 13 at its top end and by a negative electrode 16 at its bottom end. The illustration of the lead wires is omitted.

As shown in the figure, in this embodiment, the printing 26 provided continuously at the entire outside circumference of the end of the ceramic envelope 12 at the negative electrode 16 side covers the connected part 30 of the ceramic envelope 12 and the negative electrode 16. This enables entry of moisture from the microscope cavities at the connected part 30 to be prevented.

### Effects of Contamination: Test Results

The inventors investigated the insulation degradation due to contamination and the effect of prevention of this by printing according to the present invention. They measured the discharge voltage in the following five states for discharge tubes with rated discharge voltages of 850V.

No. 1: Discharge voltage in positive direction in state of clean surface

No. 2: Discharge voltage in negative direction in state of clean surface

No. 3: Discharge voltage in positive direction in state with carbon deposited on positive electrode end in stripe shape

No. 4: Discharge voltage in negative direction in state with carbon deposited on negative electrode end in stripe shape

No. 5: Discharge voltage in negative direction in state with printing according to present invention, then carbon deposited on negative electrode end in stripe shape

(Note) “Positive direction” means application of DC voltage in forward direction from positive electrode to negative electrode, while “negative direction” means application of DC voltage in reverse direction from negative electrode to positive electrode.

The results are shown in the following Table 1.

TABLE 1
Results of Measurement of Discharge Tube of Rated 850 V

| | | Measurement | |
|---|---|---|---|
| Test | | direction of | Discharge |
| no. | State | discharge voltage | voltage (V) |
| 1 | Clean surface | Positive direction | 850 |
| 2 | Clean surface | Negative direction | 850 |
| 3 | Contamination | Positive direction | 850 |
| | of positive | | |
| | electrode side | | |
| 4 | Contamination | Negative direction | 720 |
| | of negative | | |
| | electrode side | | |
| 5 | Contamination | Negative direction | 850 |
| | on printing of | | |
| | negative | | |
| | electrode side | | |

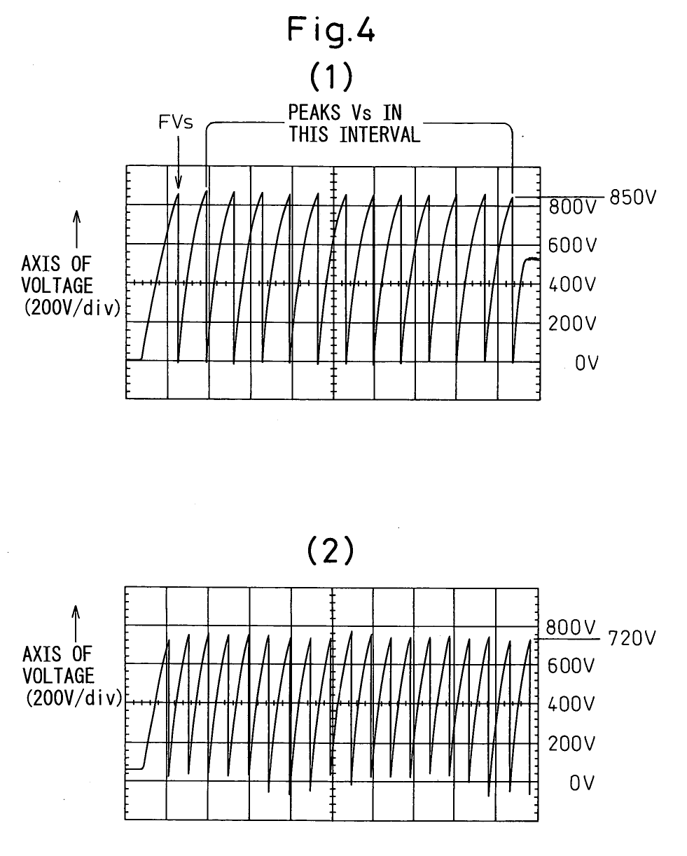

As shown in Table 1, from the results of No. 1 and No. 2, it is learned that the rated discharge voltage is obtained for both the positive and negative directions in the state of a clean surface and that the same performance is exhibited in the two directions. FIG. 4(1) shows the chart of measurement of No. 1. The same measurement chart applies to No. 2.

From the results of No. 3, it is learned that even when the positive electrode end is contaminated by the deposition of carbon, the rated discharge voltage is obtained in the same way as a clean surface and there is no effect of contamination. The measurement chart is similar to the measurement chart of No. 1 shown in FIG. 4(1).

From the results of No. 4, it is learned that when the negative electrode end is contaminated by the deposition of carbon, the discharge voltage ends up dropping sharply from the rating. FIG. 4(2) shows the measurement chart of No. 4.

From the results of No. 5, it is learned that by printing on the negative electrode end according to the present invention, even if carbon deposits on it in the same way as in No. 4, the rated discharge voltage is obtained and insulation degradation due to contamination is completely prevented. The measurement chart is similar to the measurement chart of No. 1 shown in FIG. 4(1).

In this way, by providing the printing of the present invention, it is possible to prevent insulation degradation due to contamination.

### Results of Temperature Humidity Bias (THB) Test

The inventors conducted a temperature humidity bias test. The conditions were as follows:

### Sample Conditions

Example Nos. 1 to 5 of present invention: Continuous printing on entire outside circumference of negative electrode end of ceramic envelope

Comparative Example Nos. 6 to 10: Continuous printing on entire outside circumference of positive electrode end of ceramic envelope

### Test Conditions

Temperature: 85° C.

Humidity: 85%

Bias: Constant application of DC500V

Measurement items: FVs (first discharge start voltage)

Vs (second and later discharge start voltage)

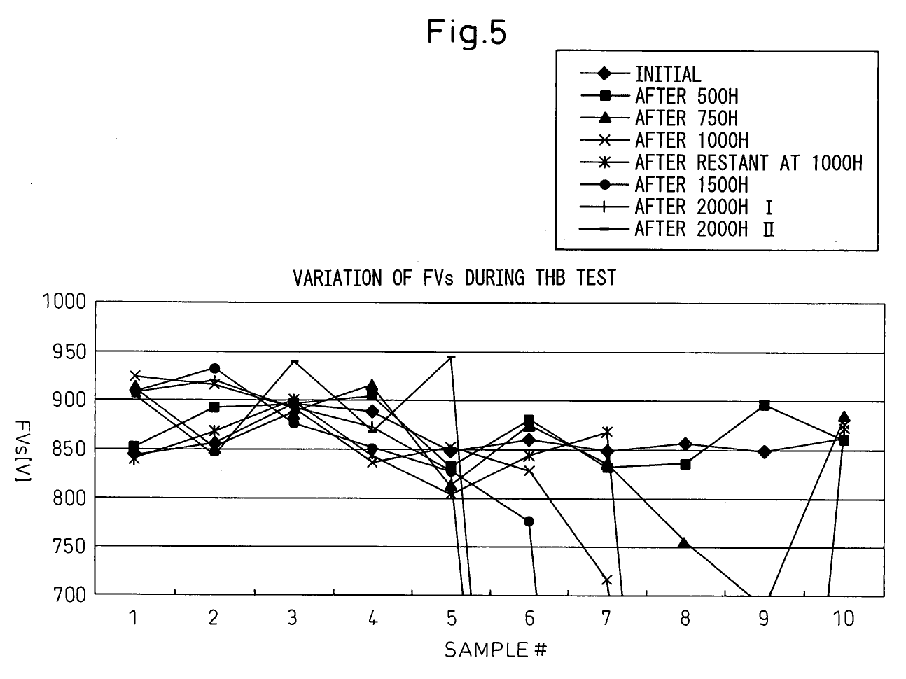

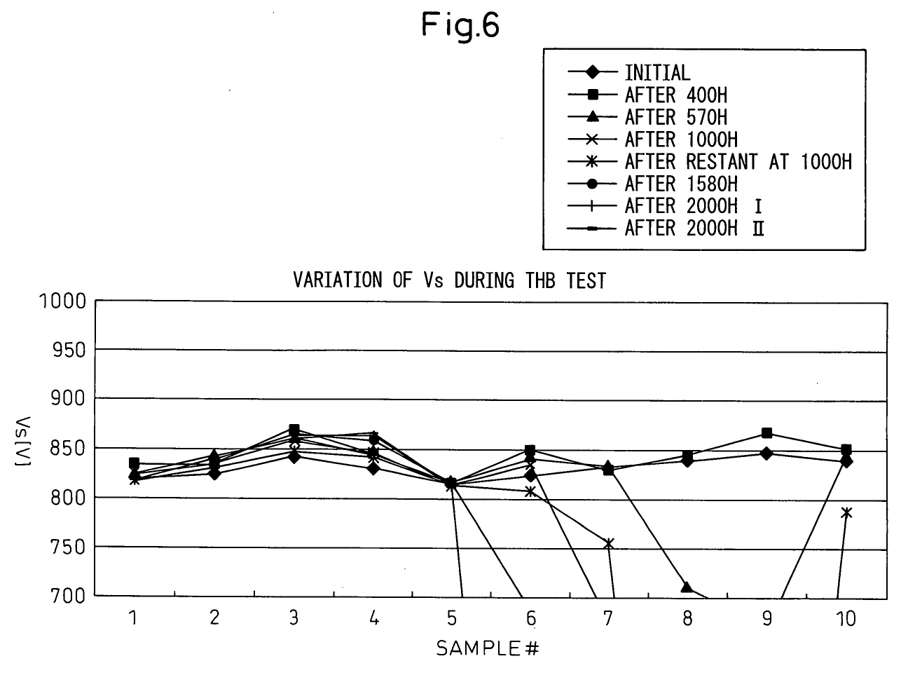

Test time: Measured for various elapsed times up to 2000 hours (for 2000 hour sample, measured twice, that is, 1) right after end of test and 2) after elapse of 1 hour from end of test). Results shown in FIG. 5 (FVs) and FIG. 6 (Vs).

As illustrated, Example Nos. 1 to 5 of the present invention printed on the negative electrode ends did not drop in discharge voltage in the test up to 2000 hours. As opposed to this, Comparative Example Nos. 6 to 10 printed on the positive electrode ends did not drop in discharge voltage in the test up to 500 hours, but samples dropping in discharge voltage began to appear after 750 hours and all samples experienced remarkable drops in discharge voltage after the elapse of 2000 hours.

In this way, by printing on the entire outside circumference of the negative electrode end of the ceramic envelope according to the present invention, it is possible to prevent insulation degradation even in a state with bias applied at a high temperature and high humidity for a long period of time.

Summarizing the effects of the invention, it is possible to provide a discharge tube preventing insulation degradation due to deposition of dirt or moisture on the surface of the envelope and greatly reduce the load in handling and maintenance and management.

While the invention has been described with reference to specific embodiments chosen for purpose of illustration, it should be apparent that numerous modifications could be made thereto by those skilled in the art without departing from the basic concept and scope of the invention.

1. A discharge tube comprised of a cylinder ceramic envelope sealed at its two ends by plate-shaped positive electrode and negative electrode, wherein
the entire outside circumference of at least the negative electrode end of the ceramic envelope is printed with insulating ink.

2. A discharge tube as set forth in claim 1, wherein said printing is continuous or intermittent.

3. A discharge tube as set forth in claim 1, wherein said printing covers at least a connecting part of the negative electrode end of said ceramic envelope and said negative electrode.

4. A discharge tube as set forth in claim 1, wherein a bar code is given by said printing.

5. A discharge tube as set forth in claim 3, wherein a bar code is given by said printing.
